(19) United States
(12) Patent Application Publication
(10) Pub. No.: US 2016/0332097 A1
(43) Pub. Date: Nov. 17, 2016

(54) APPARATUS FOR COLLECTING PAINT CHIPS AND OTHER DEBRIS AND METHOD OF USING SAME

(71) Applicant: Scott R. Tetterton, Rockwell, NC (US)

(72) Inventor: Scott R. Tetterton, Rockwell, NC (US)

(21) Appl. No.: 14/711,956

(22) Filed: May 14, 2015

(51) Int. Cl. B01D 29/01

(52) U.S. Cl. CPC B01D 29/01

(57) ABSTRACT

An apparatus for collecting paint chips and other fine debris includes a mesh screen layer attached to a frame. The frame has an outer edge portion enclosing at least a portion of the mesh screen layer. At least one first fastening member and at least one second fastening member can be positioned on the outer edge portion of the frame, and are adapted for complementary engagement with each other. The frame can be made of canvas cloth, and the mesh screen layer can be made of nylon.

### TECHNICAL FIELD AND BACKGROUND OF THE INVENTION

The present invention relates to an apparatus for collecting paint chips and other fine debris. An embodiment of the invention is particularly adapted for collecting paint chips and other debris that is generated when the exterior of a building is power washed.

It is often necessary to power wash the exterior of a building structure, such as a house, prior to painting. The power washing typically results in a great deal of paint chips and other small debris falling off the house exterior onto the ground below. It can be very difficult and time consuming to collect and remove the paint chips and other debris the grass, bushes, trees and other vegetation surrounding the house, resulting in significant added time and expense to the paint job. High wind can exacerbate the problem by further spreading the paint chips and other debris away from the house.

Painters have attempted to address this problem by positioning drop cloths around the house when it is being power washed. However, such drop cloths are not effective in collecting in the paint chips and other small debris generated during power washing as they can easily slide off of the drop cloth.

### SUMMARY OF INVENTION

Therefore, one object of the present invention is to provide an apparatus adapted for collecting paint chips and other fine debris generated during the power washing of a building structure, such as the exterior of a house. These and other objects of the invention can be obtained in the preferred embodiments of the invention described below.

One embodiment of the present invention comprises an apparatus for collecting debris comprising a mesh screen layer, and a frame section attached to the mesh screen layer. The frame section has an outer edge portion enclosing at least a portion of the mesh screen layer. At least one first fastening member and at least one second fastening member are positioned on the frame section, and are adapted for complementary engagement with each other.

According to another embodiment of the invention, the outer edge portion of the frame section encloses the mesh screen layer and the fastening members are positioned on the outer edge portion.

According to another embodiment of the invention, the fastening members comprise a plurality of hook and loop fasteners.

According to another embodiment of the invention, the outer edge portion of the frame section is substantially rectangular and comprises a first side, a second side, a third side and a fourth side. The first side and the second side are substantially parallel, and the third side and the fourth side are substantially parallel.

According to another embodiment of the invention, the first fastening member comprises a first plurality of hook fasteners positioned on a top surface of the first side of the outer edge portion of the frame section, and the second fastening member comprises a first plurality of loop fasteners positioned on a top surface of the second side of the outer edge portion of the frame section.

According to another embodiment of the invention, the first fastening member further comprises a second plurality of hook fasteners positioned on the top surface of the third side of the outer edge portion of the frame section, and the second fastening member further comprises a second plurality of loop fasteners positioned on the top surface of the fourth side of the outer edge portion of the frame section.

According to another embodiment of the invention, the first fastening member further comprises a third plurality of hook fasteners positioned on the bottom surface of the second side of the outer edge portion of the frame section, and a fourth plurality of hook fasteners positioned on the bottom surface of the fourth side of the outer edge portion of the frame section.

According to another embodiment of the invention, the second fastening member further comprises a third plurality of loop fasteners positioned on the bottom surface of the first side of the outer edge portion of the frame section, and a fourth plurality of loop fasteners positioned on the bottom surface of the third side of the outer edge portion of the frame section.

According to another embodiment of the invention, the frame section further comprises a first inner support portion extending from the first side of the outer edge portion to the second side of the outer edge portion, the first inner support portion being substantially parallel to the third and fourth sides of the outer edge portion.

According to another embodiment of the invention, the frame section further comprises second and third inner support portions extending from the third side of the outer edge portion to the fourth side of the outer edge portion, the second and third inner support portions being substantially parallel to the first and second sides of the outer edge portion, whereby the first, second and third inner support portions of the frame section divide the mesh screen layer into six mesh screen layer sections having substantially equal areas.

According to another embodiment of the invention, the frame section comprises a top layer of material and a bottom layer of material. An outer edge of the mesh screen layer is positioned intermediate the top layer and the bottom layer of the fame and held therein by attachment of the top layer to the bottom layer.

According to another embodiment of the invention, the top layer and the bottom layer of the frame section are sewn together.

According to another embodiment of the invention, the top layer and the bottom layer of the frame section are comprised of canvas cloth.

According to another embodiment of the invention, the mesh screen layer comprises nylon.

According to another embodiment of the invention, the frame section is made of canvas cloth.

According to another embodiment of the invention, the frame section is adapted to float on water.

Another embodiment of the invention comprises a kit comprised of first and second apparatuses adapted for collecting fine debris. Each apparatus comprises a mesh screen layer, and a frame section attached to the mesh screen layer. The frame section comprises an outer edge portion substantially enclosing the mesh screen layer, and first and second fastening members positioned on the frame section. The fastening members are adapted for complementary releasable engagement with each other. As such, the first apparatus can be releasably attached to the second apparatus by releasable engagement of the first fastening member of the first apparatus with the second fastening member of the second apparatus.

According to another embodiment of the invention, the outer edge portion of the frame section of each apparatus is substantially rectangular and comprises a first side, a second side, a third side and a fourth side, wherein the first side and the second side are substantially parallel, and the third side and the fourth side are substantially parallel.

According to another embodiment of the invention, the first fastening member comprises a first plurality of hook fasteners positioned on a top surface of the first side of the outer edge portion of the frame section and a second plurality of hook fasteners positioned on a top surface of the third side of the outer edge portion of the frame section, and the second fastening member comprises a first plurality of loop fasteners positioned on a top surface of the second side of the outer edge portion of the frame section and a second plurality of loop fasteners positioned on the fourth side of the outer edge portion of the frame section.

Another embodiment of the invention comprises a method of collecting paint chips and other debris generated during power washing of a building exterior, in which first and second apparatuses are used. Each apparatus comprises a mesh screen layer, and a frame section attached to the mesh screen layer. The frame section comprises an outer edge portion substantially enclosing the mesh screen layer. First and second fastening members are positioned on the frame section, and adapted for complementary releasable attachment with each other. The first apparatus can be positioned on a ground surface proximate the building exterior, and the second apparatus can be positioned on the ground surface adjacent to the first apparatus. The first apparatus can be releasably attached to the second apparatus by attaching the first fastening member of the first apparatus with the second fastening member of the second apparatus.

According to another embodiment of the invention, the first fastening member can be comprised of a plurality of hook fasteners, and the second fastening member can be comprised of a plurality of loop fasteners.

According to another embodiment of the invention, the first fastening member can be comprised of a plurality of loop fasteners, and the second fastening member can be comprised of a plurality of hook fasteners.

According to another embodiment of the invention, the mesh screen layer is comprised of nylon, and the frame section is comprised of cotton canvas cloth.

### BRIEF DESCRIPTION OF THE DRAWINGS

FIG. 1 is a top plan view of an apparatus for collecting paint chips and similar debris according to a preferred embodiment of the invention;

FIG. 2 is an enlarged partial view of the apparatus of FIG. 1;

FIG. 3 is a cross sectional view taken along lines 3-3 in FIG. 2;

FIG. 5 is a perspective view of the apparatus of FIG. 1;

FIG. 6 is an environmental view illustrating a method of using the apparatus of FIG. 1 according to a preferred embodiment of the invention; and

FIG. 7 is a perspective view of the apparatus of FIG. 1.

### DESCRIPTION OF PREFERRED EMBODIMENTS OF THE INVENTION AND BEST MODE

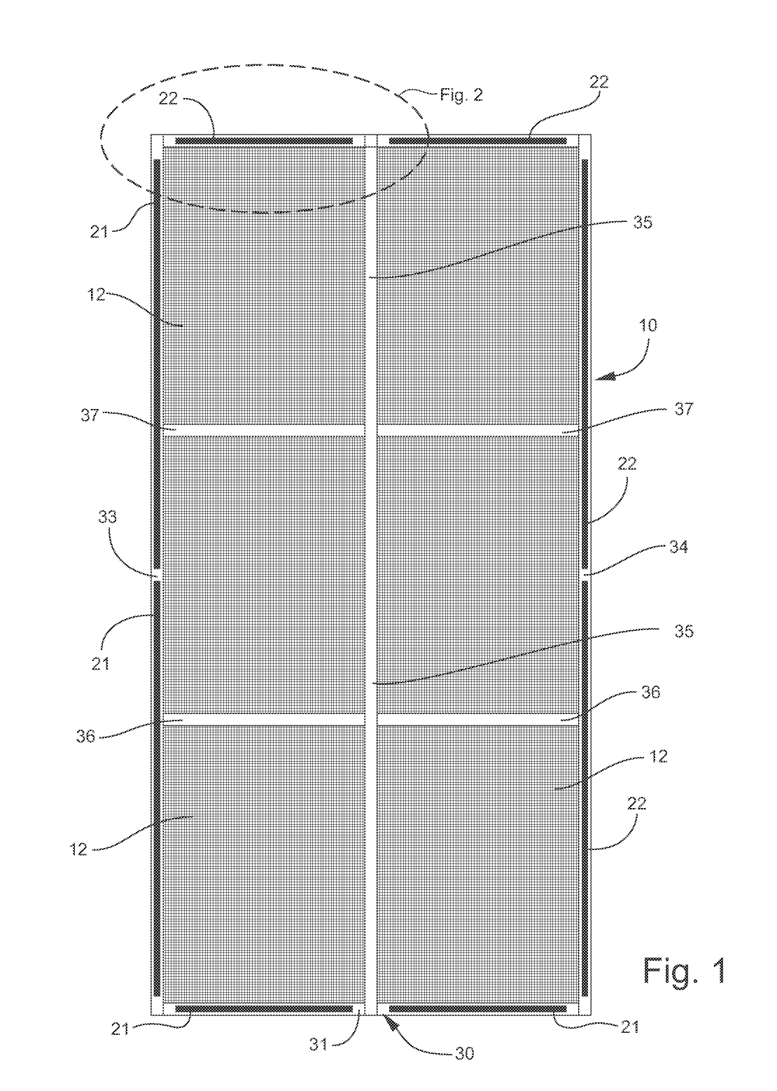

An apparatus for collecting paint chips and other debris according to a preferred embodiment of the invention is illustrated in FIGS. 1-6, and shown generally at reference numeral 10. The apparatus 10 comprises a mesh screen layer 12 that is enclosed and supported within a frame section 30, as shown in FIG. 1.

The mesh screen layer 12 can be made of nylon or other suitable material. Preferably, the mesh screen layer 12 can have a mesh hole size of about two to four millimeters.

As shown in FIG. 1, the frame 30 comprises a rectangular outer edge portion comprised of four outer side sections 31, 32, 33, 34, and an inner support portion comprised of three inner support sections 35, 36, 37. The first inner support section 35 extends longitudinally from the mid-way point of one lateral side section 31 to the mid-way point of the opposed lateral side section 32, as shown in FIG. 1. The second and third inner support sections 36, 37 extend from one longitudinal side section 33 to the opposed longitudinal side section 34, as shown in FIG. 1.

Preferably, each of the four outer side sections 31, 32, 33, 34, and each of the three inner support sections 35, 36, 37 can have a width of about four inches. Preferably, the frame 30 can be about twenty-four feet long and twelve feet wide. Alternatively, the frame 30 can be about forty-eight feet long and twelve feet wide.

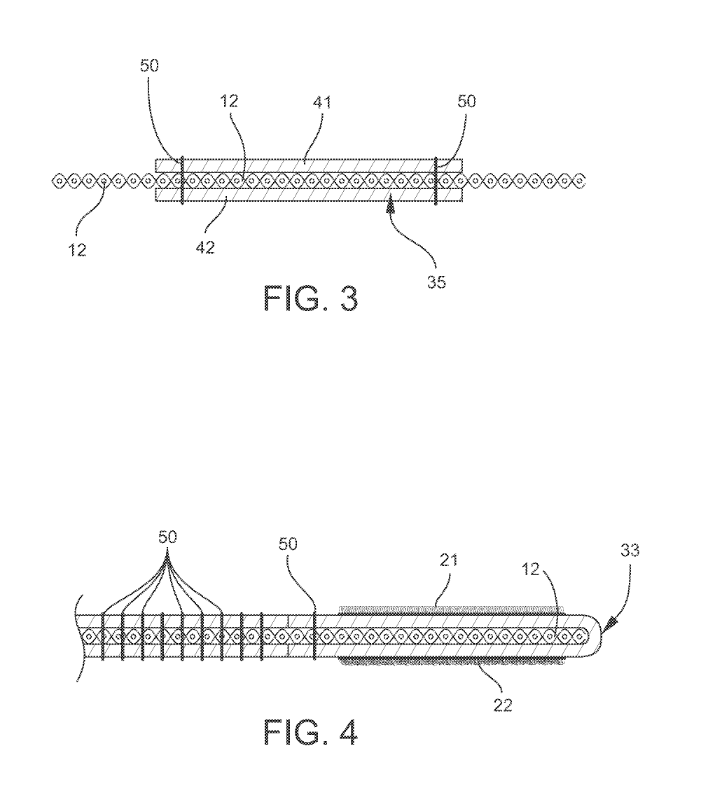

The frame 30 can be comprised of canvas cloth, or other suitable material. Preferably, the frame 30 is comprised of six to twelve ounce cotton canvas cloth. The frame 30 can be comprised of two layers of material that can be positioned as top and bottom layers 41, 42, respectively, as shown in FIGS. 3 and 4.

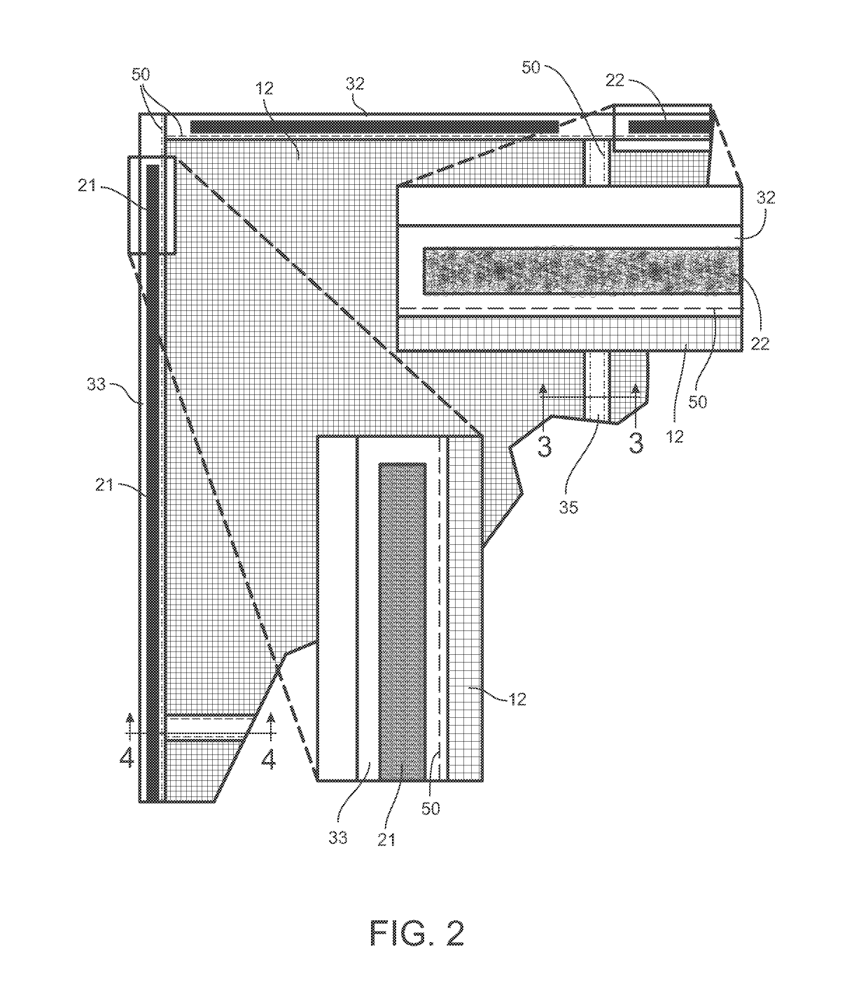

The mesh screen layer 12 can be attached to the frame 30 by positioning the mesh layer 12 between the top and bottom layers 41, 42 of the frame 30 and sewing the top and bottom layers 41, 42 together along seams 50, as shown in FIGS. 2-4. Alternatively, the top and bottom layers 41, 42 can be attached together using other suitable means, such as an adhesive.

As shown in FIG. 1, the inner support sections 35, 36, 37 divide the mesh screen layer 12 into six rectangular sections of approximately equal area. As such, the inner support sections 35, 36, 37 prevent a tear in one section of the mesh screen layer 12 from continuing and spreading into the other sections. Alternatively, less than or more than three inner support sections 35, 36, 37 can be utilized in the apparatus 10.

The apparatus 10 includes first and second fastening members that are adapted for complementary releasable engagement with each other. The fastening members can be sections of hook and loop fasteners 21, 22, respectively. Alternatively, the fastening members can be other suitable complementary fasteners, such as rings and buckles.

Hook fastener sections 21 can be positioned on the top surface of one lateral outer side section 31 and one longitudinal outer side section 33, and loop fastener sections 22 can be positioned on the top surface of the opposite lateral outer side section 32, and the opposite longitudinal side section 34, as shown in FIG. 1. In addition, loop fastener sections 22 can be positioned on the bottom surface of the first outer side section 31 and the third side section 33, and hook fastener sections 21 can be positioned on the second outer side section 32 and the fourth outer side section 34. Alternatively, the positions of the hook and loop fastener sections 21, 22 can be reversed.

Each of the hook fastener sections 21 can be strips having a plurality of hook fasteners formed thereon that that can be attached to the surface of the frame 30 by an adhesive. Likewise, the loop fastener sections 22 can be strips having a plurality of loop fasteners formed thereon that that can be attached to the surface of the frame outer side sections 31, 32, 33, 34 by an adhesive. Alternatively, the hook and loop fastener sections 21, 22 can be strips of hook and loop fasteners that are sewn to the side sections 31, 32, 33, 34. In another alternative embodiment, the hook and loop fastener sections 21, 22 can comprise hook and loop fasteners that are integrally formed on the surface of the frame outer side sections 31, 32, 33, 34. Preferably, each of the hook and loop fastener sections 21, 22 have a width of about two inches. By positioning hook and loop fastener sections 21, 22 on both the top and bottom surfaces of the frame side sections 31, 32, the apparatus 10 can be easily mated with additional like apparatuses.

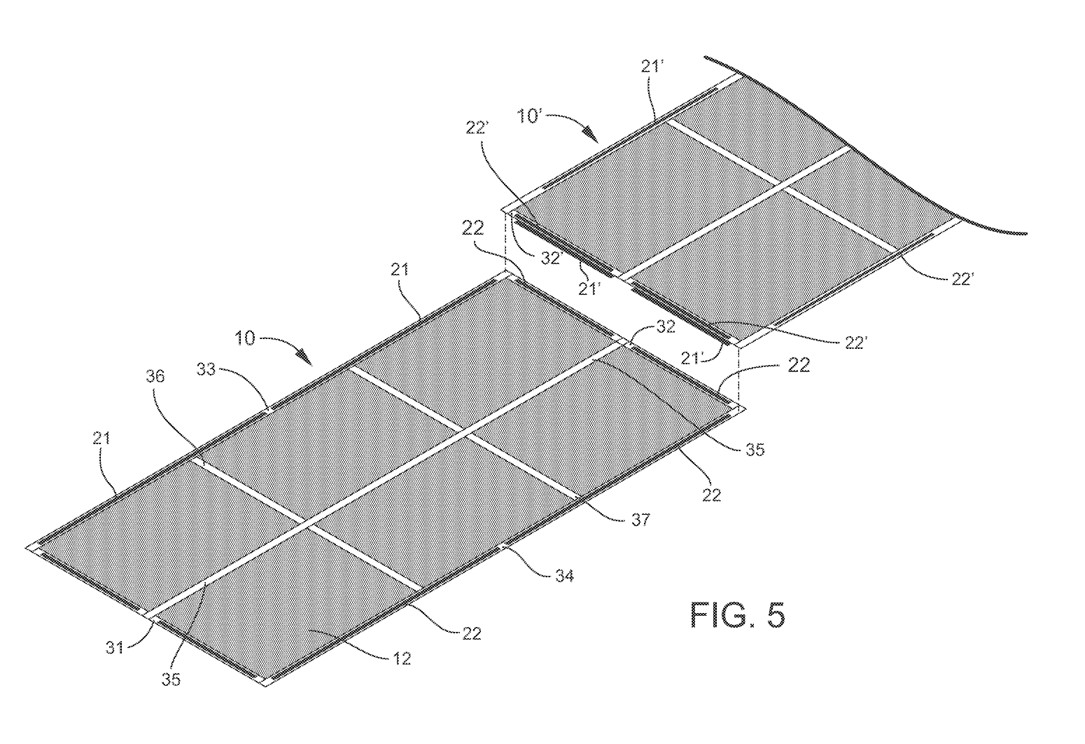

As shown in FIG. 5, the apparatus 10 can be attached to a second identical apparatus 10′ by engaging the loop fasteners 22 on the top surface of the second side section 32 of the apparatus 10 with hook fasteners 21 on the bottom surface of the second side section 32′ of the second apparatus 10′. As such, the attachment configuration of the apparatuses 10, 10′ can provide additional effective length for capturing and collecting paint chips and other debris.

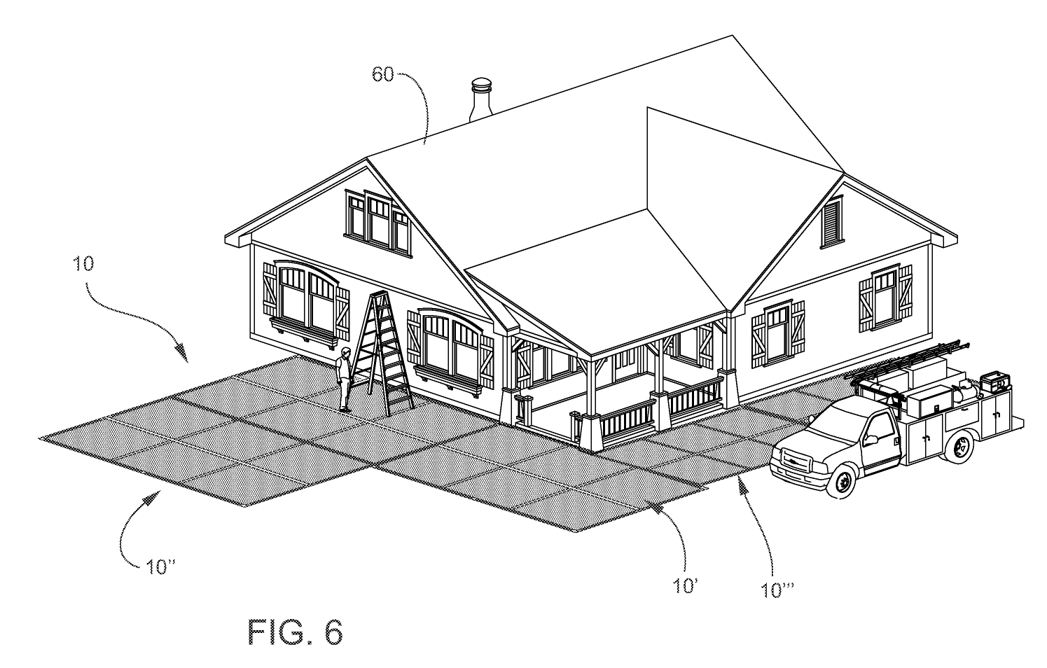

FIG. 6 illustrates a method of using the apparatus 10 according to a preferred embodiment of the invention. As shown in FIG. 6, a plurality of identical apparatuses 10, 10′, 10″, 10′″ can be positioned on a ground surface around a building structure, such as a house 60. One apparatus 10 can be releasably attached to a second apparatus 10′ by engaging the loop fasteners 22 on the top surface of the second side section 32 of the apparatus 10 with hook fasteners 21 on the bottom surface of the second side section 32′ of the second apparatus 10′, as shown in FIG. 5. Likewise, the apparatus 10 can be releasably attached to another apparatus 10″, and the second apparatus 10″ can be attached to a fourth apparatus 10′″, as shown in FIG. 6, and so on. Additional apparatuses can be releasably attached to each other until the desired coverage around the house 60 is achieved. The apparatus can also be used to cover bushes and other vegetation.

The house 50 can then be power washed. Paint chips and other debris that is caused to fall off the exterior of the house by the power washing falls onto the apparatuses 10, 10′, 10″, 10′″ positioned around the house 50. The paint chips and other debris are captured in the mesh screen layer 12. The mesh screen layer 12 provides frictional engagement with the paint chips and other debris, preventing them from easily sliding off of the apparatus 10. When the power washing is complete the apparatuses 10, 10′, 10″, 10′″ can be gathered up with the collected paint chips and debris contained therein and taken away for proper disposal. When apparatuses 10, 10′, 10″, 10′″ can be detached from each other until being used again

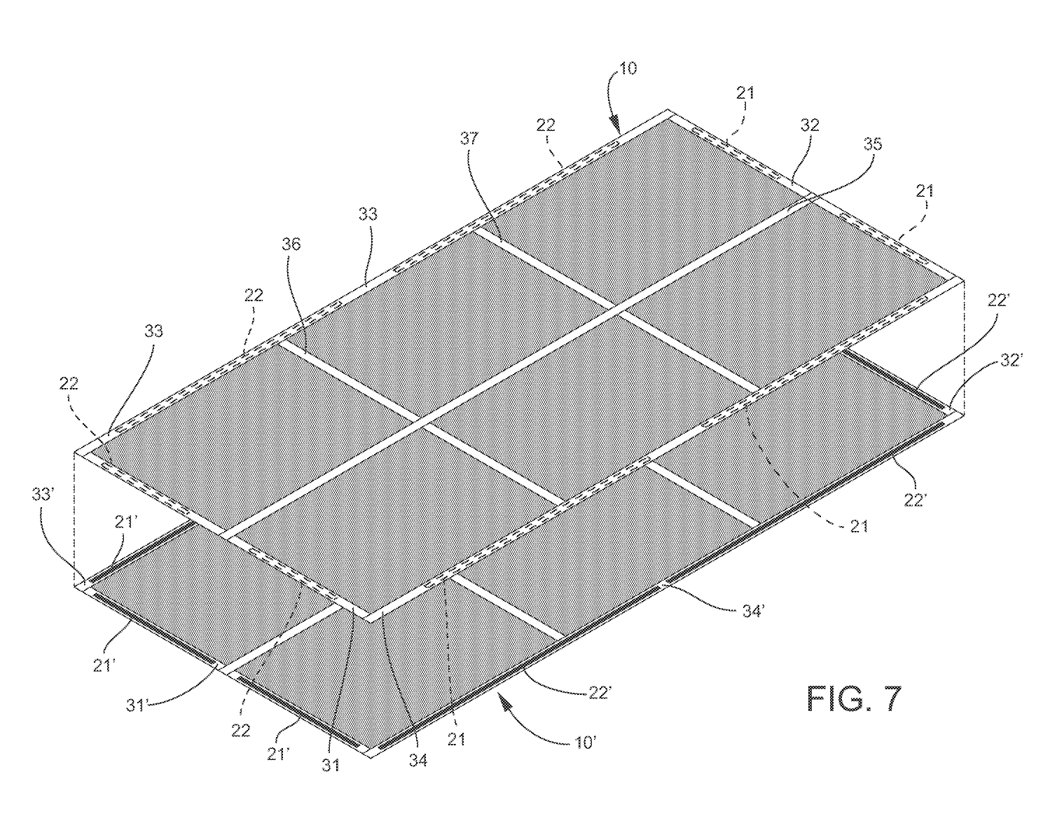

Alternatively, it may be desirable to overlay one apparatus 10 completely on another apparatus 10′, as shown in FIG. 7. In this configuration, the loop fastener sections 22 on the bottom surface of the first and third side sections 31, 33 of the first apparatus 10 mate with the hook fastener sections 21′ on the top surface of the first and third side sections 31′, 33′ of the second apparatus 10′, and the hook fastener sections 22 on the bottom surface of the second and fourth side sections 32, 34 of the first apparatus 10 mate with the loop fastener sections 21′ on the top surface of the second and fourth side sections 32′, 34′.

It should be noted that the apparatus 10 can be used in applications other than collecting paint chip debris during building exterior power washing. The apparatus 10 can be used to collect scrapings, rust, marine coatings, rotten wood and other small debris.

In an alternative embodiment of the invention, the frame 30 can have an inflatable member inserted therein, or the frame 30 itself can be inflatable, so that the frame 30 can float and the apparatus 10 can be used on the water. As such, the apparatus 10 can be used to collect paint chips and other debris generated during the power washing of boats and ships.

An apparatus for collecting paint chips and other debris and a method of using same are described above. Various changes can be made to the invention without departing from its scope. The foregoing description of embodiments and best mode of the invention are provided for the purpose of illustration only and not limitation—the invention being defined by the claims and equivalents thereof.

What is claimed is:

1. An apparatus for collecting debris comprising:
(a) a mesh screen layer;
(b) a frame section attached to the mesh screen layer, the frame section comprising an outer edge portion enclosing at least a portion of the mesh screen layer; and
(c) at least one first fastening member and at least one second fastening member positioned on the frame section, and adapted for complementary engagement with each other.

2. The apparatus according to claim 1, wherein the outer edge portion of the frame section encloses the mesh screen layer, and the at least one first fastening member and the at least one second fastening member are positioned on the outer edge portion.

3. The apparatus according to claim 2, wherein the at least one first fastening member comprises a plurality of hook fasteners, and the at least one second fastening member comprises a plurality of loop fasteners.

4. The apparatus according to claim 2, wherein the outer edge portion of the frame section is substantially rectangular and comprises a first side, a second side, a third side and a fourth side, wherein the first side and the second side are substantially parallel, and the third side and the fourth side are substantially parallel.

5. The apparatus according to claim 4, wherein the at least one first fastening member comprises a first plurality of hook fasteners positioned on a top surface of the first side of the outer edge portion of the frame section, and the at least one second fastening member comprises a first plurality of loop fasteners positioned on a top surface of the second side of the outer edge portion of the frame section.

6. The apparatus according to claim 5, wherein the at least one first fastening member further comprises a second plurality of hook fasteners positioned on the top surface of the third side of the outer edge portion of the frame section, and the at least one second fastening member further comprises a second plurality of loop fasteners positioned on the top surface of the fourth side of the outer edge portion of the frame section.

7. The apparatus according to claim 6, wherein the at least one first fastening member further comprises a third plurality of hook fasteners positioned on the bottom surface of the second side of the outer edge portion of the frame section, and a fourth plurality of hook fasteners positioned on the bottom surface of the fourth side of the outer edge portion of the frame section.

8. The apparatus according to claim 7, wherein the at least one second fastening member further comprises a third plurality of loop fasteners positioned on the bottom surface of the first side of the outer edge portion of the frame section, and a fourth plurality of loop fasteners positioned on the bottom surface of the third side of the outer edge portion of the frame section.

9. The apparatus according to claim 4, wherein the frame section further comprises a first inner support portion extending from the first side of the outer edge portion to the second side of the outer edge portion, the first inner support portion being substantially parallel to the third and fourth sides of the outer edge portion.

10. The apparatus according to claim 9, wherein the frame section further comprises second and third inner support portions extending from the third side of the outer edge portion to the fourth side of the outer edge portion, the second and third inner support portions being substantially parallel to the first and second sides of the outer edge portion, whereby the first, second and third inner support portions of the frame section divide the mesh screen layer into six mesh screen layer sections having substantially equal areas.

11. The apparatus according to claim 1, wherein the frame section comprises a top layer of material and a bottom layer of material, an outer edge of the mesh screen layer is positioned intermediate the top layer and the bottom layer of the fame and held therein by attachment of the top layer to the bottom layer.

12. The apparatus according to claim 11, wherein the top layer and the bottom layer of the frame section are sewn together.

13. The apparatus according to claim 11, wherein the top layer and the bottom layer of the frame section are comprised of canvas cloth.

14. The apparatus according to claim 1, wherein the mesh screen layer comprises nylon.

15. The apparatus according to claim 14, wherein the frame section comprises canvas cloth.

16. A kit comprising first and second apparatuses for collecting fine debris, wherein each apparatus comprises:
(a) a mesh screen layer;
(b) a frame section attached to the mesh screen layer, the frame section comprising an outer edge portion substantially enclosing the mesh screen layer; and
(c) a first fastening member and a second fastening member positioned on the frame section, and adapted for complementary releasable engagement with each other, whereby the first apparatus can be releasably attached to the second apparatus by releasable engagement of the first fastening member of the first apparatus with the second fastening member of the second apparatus.

17. The kit according to claim 16, wherein the outer edge portion of the frame section is substantially rectangular and comprises a first side, a second side, a third side and a fourth side, wherein the first side and the second side are substantially parallel, and the third side and the fourth side are substantially parallel.

18. The apparatus according to claim 17, wherein the first fastening member comprises a first plurality of hook fasteners positioned on a top surface of the first side of the outer edge portion of the frame section and a second plurality of hook fasteners positioned on a top surface of the third side of the outer edge portion of the frame section, and the second fastening member comprises a first plurality of loop fasteners positioned on a top surface of the second side of the outer edge portion of the frame section and a second plurality of loop fasteners positioned on the fourth side of the outer edge portion of the frame section.

19. A method of collecting paint chips and other debris generated during power washing of a building exterior comprising:
(a) providing first and second apparatuses, wherein each of said first and second apparatuses comprises:
(i) a mesh screen layer,
(ii) a frame section attached to the mesh screen layer, the frame section comprising an outer edge portion substantially enclosing the mesh screen layer; and
(iii) a first fastening member and a second fastening member positioned on the frame section, and adapted for complementary releasable attachment with each other;
(b) positioning the first apparatus on a ground surface proximate the building exterior; and
(c) positioning the second apparatus on the ground surface adjacent to the first apparatus; and
(d) releasably attaching the first apparatus to the second apparatus by attaching the first fastening member of the first apparatus with the second fastening member of the second apparatus.

20. The method of claim 19, wherein the at least one first fastening member comprises a plurality of hook fasteners, and the at least one second fastening member comprises a plurality of loop fasteners.
